(19) United States
(12) Patent Application Publication
(10) Pub. No.: US 2007/0140133 A1
(43) Pub. Date: Jun. 21, 2007

(54) Methods and systems for providing outage notification for private networks

(75) Inventors: Chandu Gudipalley, Mableton, GA (US); Scott K. Sheppard, Decatur, GA (US); Shahram Amid, Atlanta, GA (US)

Correspondence Address: MERCHANT & GOULD BELLSOUTH CORPORATION, P.O. BOX 2903, MINNEAPOLIS, MN, 55402, US

(73) Assignee: BellSouth Intellectual Property Corporation, Wilmington, DE (US)

(21) Appl. No.: 11/300,754

(22) Filed: Dec. 15, 2005

(51) Int. Cl. H04J 3/14

(52) U.S. Cl. 370/242; 370/252

(57) ABSTRACT

Systems and methods provide outage notification. The disclosed systems and methods may include collecting network performance measurement data and processing the collected network performance measurement data in to a plurality of child events. Furthermore, the systems and methods may include correlating the plurality of child events according to at least one rule into a parent event. Moreover, the systems and methods may include generating a trouble ticket based upon the parent event.

### RELATED APPLICATION

Related U.S. patent application Ser. No. ______, filed on even date herewith in the name of Scott K. Sheppard, and entitled “METHODS AND SYSTEMS FOR PROVIDING PERFORMANCE TESTING FOR PRIVATE NETWORKS,” assigned to the assignee of the present application, is hereby incorporated by reference.

### BACKGROUND OF THE INVENTION

I. Field of the Invention

The present invention generally relates to methods and systems for providing outage detection and notification for private networks. More particularly, the present invention relates to providing outage notification, for example, to support service level agreements for networks that include virtual private networks.

II. Background Information

A virtual private network (VPN) is a network that is configured within a public network (e.g. a service provider's network or the Internet) in order to take advantage of the economies of scale and management facilities of large networks. VPNs are widely used by enterprises to create wide area networks (WANs) that span large geographic areas, to provide site-to-site connections to branch offices, and to allow mobile users to dial up their enterprise's local area network (LAN). In other words, a VPN is a private network that uses a public network to connect remote sites or users together. Instead of using dedicated connections, such as leased lines, a VPN uses “virtual” connections routed through a public network from an enterprise's private network to a remote site or user.

Service providers provide networking services to customers according to service level agreements (SLA). Consequently, service providers take measurements on their networks in order to ensure service is provided to the customer at least at the level defined by the SLA. Furthermore, these customers have networks comprising one or more virtual routing and forwarding networks (VRFs) (virtual routing and forwarding, a part of memory carved out of a router to support the routing tables associated with a VPN) the functional portion of a VPN including customer premise equipment (CPE). Currently, service providers cannot make cost effective active measurements to CPE devices that are supported by a VRF.

Taking performance measurements on CPE in a VPN is problematic because normally, a VPN is a closed private network. That is, unless a device is a part of the VPN, it cannot communicate with any device within the VPN. This privacy level is one reason for VPNs' popularity. This poses a network performance testing problem, however. For example, if the VPN's performance is to be measured from a singe test point (or multiple test points), then a device controlled by the service provider needs to be dedicated to that VPN only. This strategy is cost prohibitive. For example, a service provider seeking to test the VPN's performance needs to maintain a device in all tested VPNs. Due to the large number of VPNs on the service provider's network, maintaining a device in all tested VPNs would be a costly solution.

In view of the foregoing, there is a need for methods and systems for providing outage notification for private networks more optimally. Furthermore, there is a need for providing outage notification, for example, to support service level agreements for networks that include virtual private networks.

### SUMMARY OF THE INVENTION

Consistent with embodiments of the present invention, systems and methods are disclosed for providing outage notification for virtual private networks.

In accordance with one embodiment, a method for providing outage notification comprises collecting network performance measurement data, processing the collected network performance measurement data in to a plurality of child events, correlating the plurality of child events according to at least one rule into a parent event, and generating a trouble ticket based upon the parent event.

According to another embodiment, a system for providing outage notification comprising a memory storage for maintaining a database and a processing unit coupled to the memory storage, wherein the processing unit is operative to collect network performance measurement data, process the collected network performance measurement data in to a plurality of child events, correlate the plurality of child events according to at least one rule into a parent event, and generate a trouble ticket based upon the parent event.

In accordance with yet another embodiment, a computer-readable medium which stores a set of instructions which when executed performs a method for providing outage notification, the method executed by the set of instructions comprising collecting network performance measurement data, processing the collected network performance measurement data in to a plurality of child events, correlating the plurality of child events according to at least one rule into a parent event, and generating a trouble ticket based upon the parent event.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram of an exemplary outage notification system consistent with an embodiment of the present invention;

FIG. 2 is a block diagram of an exemplary communication system consistent with an embodiment of the present invention;

FIG. 3 is a flow chart of an exemplary method for providing outage notification consistent with an embodiment of the present invention;

FIG. 4 is a flow chart of an exemplary method for providing performance testing consistent with an embodiment of the present invention; and

FIG. 5 is a block diagram illustrating the correlation of a plurality of child events according to at least one rule into a parent event consistent with an embodiment of the present invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding stages to the disclosed methods. Accordingly, the following detailed description does not limit the invention. Instead, the proper scope of the invention is defined by the appended claims.

Systems and methods consistent with embodiments of the present invention provide outage notification for private networks. For example, a service provider may have an SLA with a customer. The SLA may specify a number of service levels, operational processes, and procedural processes on a network. Consistent with embodiments of the present invention, fault and trouble management systems support SLAs including, for example, SLAs with customers having VPNs. An SLA may be defined on the availability of the network corresponding to the VPN. A network availability metric may be calculated that is dependent on trouble ticket information as recorded in a trouble management processor. Consistent with embodiments of the invention, the service provider may provide network services where service degradation and service outage is automatically detected by network management tools and reported to the customer through the trouble management processor. For customers having customer VPNs, for example, service outages and service degradations may be detected and reported. Service degradation occurs when the network performance drops below acceptable values as defined in the SLA. Service outage occurs when the customer experiences a complete loss in the ability to transmit data over the network. This is usually when a network device such as router, switch or its constituent elements such as interfaces fail to operate.

Consistent with embodiments of the invention, the service provider's network is designed to offer differentiated IP services based on various network traffic classes such as, but not limited to: i) best effort; ii) business premium; iii) interactive; and iv) real-time. Based on the service provider's network infrastructure, the service provider may offer end-to-end service level guarantees on a per class and per subscriber basis. This may give the ability to prioritize traffic within a network so that certain applications, like voice and video, for example, get precedence over traffic like email and ftp, and may be guaranteed certain minimal quality of service for each class that may include availability and network performance measurements such as latency, packet loss, and jitter, for example. In addition, the service provider's customers may demand a proactive approach to service management so that the service provider reacts to service degradation such as when network performance falls below minimal acceptable levels or before a service outage when a complete loss of customer's ability to transmit data occurs. Consequently, SLAs may be offered by the service provider on the differentiated IP services to customers (e.g. business and other retail customers) having VPNs.

To enable end-to-end service level guarantees on a per class and/or per subscriber basis, consistent with embodiments of the invention, the service provider's network may be instrumented with software programs referred to as software agents such as, but not limited to, service assurance agent (SAA) available from CISCO SYSTEMS, INC. of San Jose, Calif. These service agents can measure service level metrics such as latency, jitter, and packet delivery, for example, across the service providers core or backbone network and access circuits for each network traffic classes (e.g. best effort, business premium, interactive, and real-time).

Furthermore, systems and methods consistent with embodiments of the present invention provide outage notification for private networks. Normally, a VPN is a closed customer network within a larger service provider's network. For example, unless a device is a part of the VPN, it cannot communicate with any device within the VPN. This poses a network performance testing problem, for example, if the VPN's performance is to be measured from a singe test point. In this case, a device controlled by the service provider needs to be dedicated to the tested VPN. Due to the large number of VPNs on the service provider's network, however, maintaining a device in all VPNs to be tested would be cost prohibitive.

In order to provide outage and service performance degradation detection and notification for virtual private networks, the service provider can provide a management VPN (MVPN) that provides limited access to devices within customer VPNs within the service provider's network. For example, a small group of test devices included in the MVPN can access customer premises equipment (CPE) devices in customer VPNs (CVPNs) within the service provider's network. Consequently, the CVPNs within the service provider's network participate in two VPNs, their own CVPN and the MVPN.

In order to support SLAs, service providers take network measurements at periodic intervals and from different measurement points, for example, CPE to the provider edge (PE) and within the provider core, or from a PE to every other PE. Consequently, service providers may measure network performance across access lines of any type within or without a VRF. This process is also agnostic regarding whether the CPE is within or without a territory service by the service provider. Conventional processes cannot function within a VRF since the VRF is a private network. In the past, to address this problem with conventional processes, dedicated equipment was needed for each VRF. If a provider supports thousands of VRF's, this solution would be cost prohibitive. In addition, detecting network connectivity failures such as inability to transmit data from CPE to the PE or within the service provider core from a PE to any other PE, is also cost prohibitive with conventional processes. Accordingly, the MVPN is provided, and in conjunction with a performance software module and service provider probe processes, performance measurements can be supported from one or more devices to any CPE in any CVPN (i.e. VRF). The MVPN can perform the following functions: i) measure network performance (such as but not limited to delay round trip, delay one way, jitter round trip, jitter one way, packet loss round trip, packet loss one way, and packets out of sequence) across any layer 2 access method (e.g. Frame Relay, Ethernet, ATM); ii) measure network performance within a customer VRF from a single or more than one device that is not directly a part of the customer VRF; iii) measure network performance either within the service provider territory or across another carriers network using an inter-provider VPN model; iv) measure end-to-end network performance from CPE to the PE, within the core from a PE to every other PE, and across another access line without needing to run a specific test from a customer's first CPE to a customer's second CPE; and v) detect end-to-end network connectivity failures that for example, include, from CPE to the service provider edge (PE) of the core and within the core from one PE of the core to every other PE in the core.

An embodiment consistent with the invention comprises a system for providing outage notification for virtual private networks. The system comprises a memory storage for maintaining a database and a processing unit coupled to the memory storage. The processing unit is operative to collect network performance measurement data. In addition, the processing unit is operative to process the collected network performance measurement data in to a plurality of child events. Furthermore, the processing unit is operative to correlate the plurality of child events according to at least one rule into a parent event. Moreover, the processing unit is operative to generate a trouble ticket based upon the parent event.

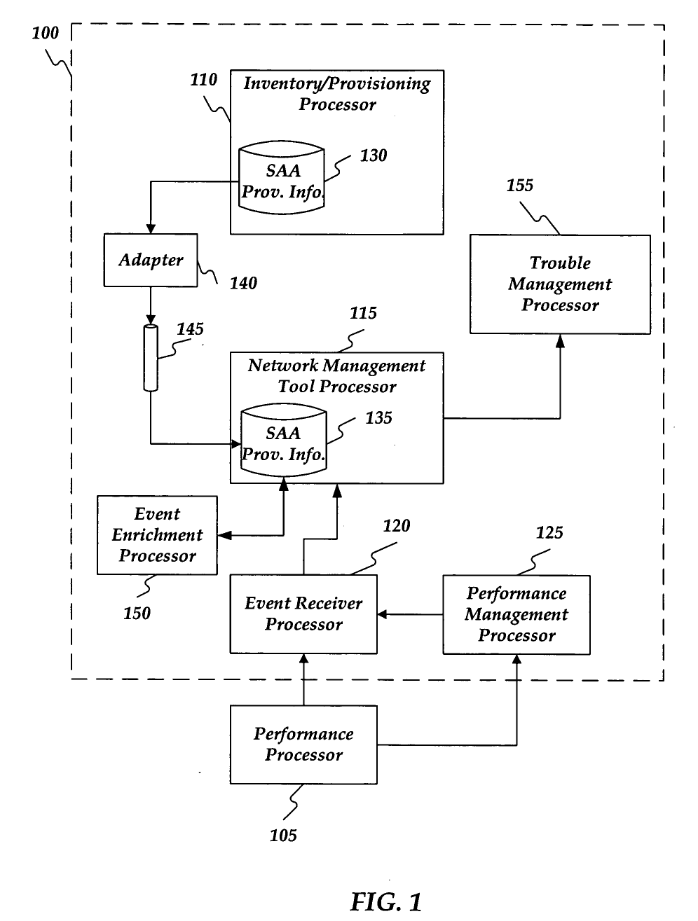

Consistent with an embodiment of the present invention, the aforementioned memory, processing unit, and other components are implemented in an outage notification system, such as an exemplary outage notification system 100 of FIG. 1. Any suitable combination of hardware, software and/or firmware may be used to implement the memory, processing unit, or other components. By way of example, the memory, processing unit, or other components is implemented with in any one or more of a performance measurement processor 105, an inventory/provisioning processor 110, a network management tool processor 115, an event receiver processor 120, and a trouble management processor 155 in combination with system 100. The aforementioned system and processors are exemplary and other systems and processors may comprise the aforementioned memory, processing unit, or other components, consistent with embodiments of the present invention.

By way of a non-limiting example, FIG. 1 illustrates system 100 in which the features and principles of the present invention may be implemented. FIG. 1 illustrates system 100 including, for example, operations support systems (OSS) components involved in monitoring, data collection and analysis, and reporting on SLAs offered to customers by the service provider. Consistent with embodiments of the invention, outage detection and notification is dependent on data collection from the network measurement probes and processing of the data by a number of these OSS. As illustrated in the block diagram of FIG. 1, system 100 includes OSS comprising, but not limited to, a performance management processor 125 configured for network performance data collection and reporting. Performance management processor 125 may use performance management software available from INFOVISTA of Herndon, Va. Furthermore, network management tool processor 115 is configured for collecting outage events generated by SAA and network devices. Network management tool processor 115 may utilize NETCOOL network management tools available from MICROMUSE INC. of San Francisco, Calif. Moreover, trouble management processor 110 is configured for trouble ticket management.

Consistent with embodiments of the present invention, performance processor 105 may provide network performance measurement data from, for example, SAAs that may be utilized by performance processor 105. The network performance statistical data is then collected and aggregated in near-real-time by performance management processor 125 for subsequent performance level reporting. The performance management processor 125 also collects performance data from network devices that include routers, switches and other network elements, for example, network interfaces. When the network performance data falls below a specific threshold, the performance management processor 125 sends notifications to the event receiver processor 120 of the outage notification system 100.

The network measurement data from, for example, SAAs also include outage information such as service performance degradation and network connectivity failures. These outages may occur, for example, when i) a device or interface on a device has failed to operate correctly or ii) excessive network congestion due to network traffic overload that prevents any new data from being sent from one point in the network, for example, a CPE to another point in the network, for example a PE or from a PE to another PE within the service provider core. Performance measurement processor 125 then generates service failure events (e.g. traps) on service level threshold violations (network service performance degradations) and on network connectivity loss (e.g. inability to transmit data from one end point of the network to another end point of the network). These notification events are sent to the event receiver processor 120 of the outage notification system 100.

Once performance measurement processor 105 sends service failure events (SM traps) to outage notification system 100, more specifically to the event receiver processor 120, event receiver processor 120 performs some computations to extract relevant information from the traps and send the processed information to the network management tool processor 115. Network management tool processor 115 then correlates the service failure events from the SAAs with other service failure events, for example, events corresponding to the network performance degradation generated by the performance management processor 125 to generate a “root cause” event that will ensure a quick identification and resolution of the problem, for example, the device or link that failed that caused the service failure event. Based on the root-cause event, a single trouble ticket may be generated by trouble management processor 155 with information, for example, the type of the service failure event the SM that detected the service failure event, the VPNs that were affected by the failure and the customers that were impacted by the failure. This information may then be used for subsequent trouble management that may include resolving the problem. Additionally, SLA analysis may then be performed periodically (e.g. every month) on the network performance data collected by performance management processor 125 and from the trouble ticket information in trouble management processor 155. Consequently, SLA reports are then created and made available to the customers.

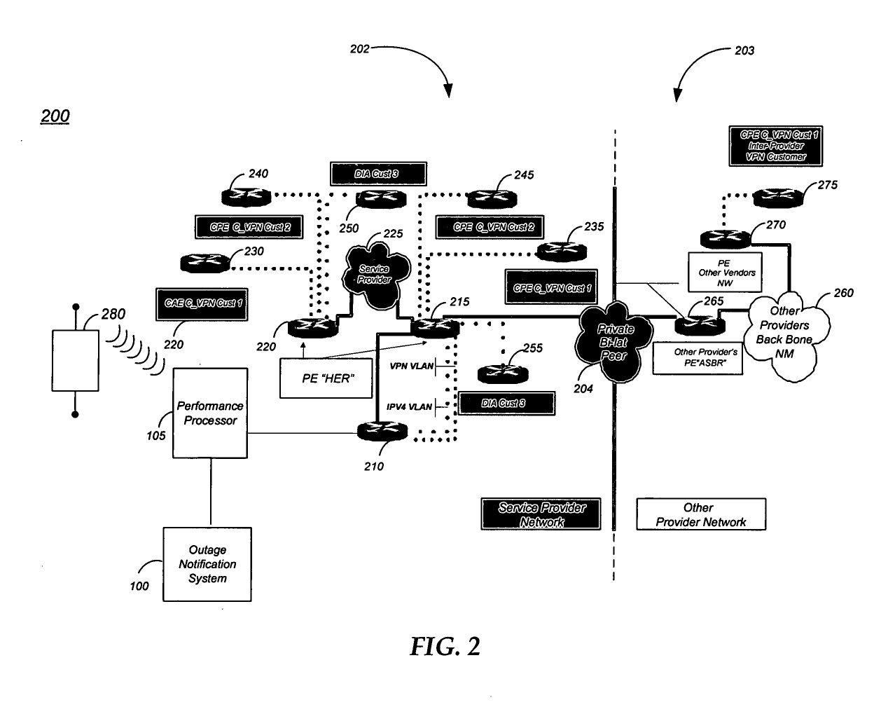

By way of a non-limiting example, FIG. 2 illustrates system 200 in which the features and principles of the present invention may be implemented. As illustrated in the block diagram of FIG. 2, system 200 includes a service provider network 202 and other provider network 203 connected through a private bi-lateral peer 204. Service provider network 202 includes performance processor 105, a shadow router 210, a first provider edge (PE) router 215, a second PE router 220, and a service provider backbone 225.

Furthermore, CPE, including, for example, routers are connected to service provider network 202. For example, service provider network 202 includes first customer CPEs 230 and 235, second customer CPEs 240 and 245, and third customer CPEs 250 and 255. First customer CPEs 230 and 235 are associated as a first VPN and second customer CPEs 240 and 245 are associated with a second VPN. Third customer CPEs 250 and 255 are not associated with a VPN.

Other provider network 203 includes other provider backbone 260 and other provider PE's 265 and 270. In addition, other provider network 203 includes an additional first customer CPE 275. First customer CPEs 230, 235, and 275 may be associated as an “interprovider VPN”, which comprises an interaction between service provider network 202 and other service provider network 203. An interprovider VPN is used to support sharing VPN information across two or more carrier's networks. This allows the service provider to support customer VPN networks, for example, outside the service provider's franchise or region.

Shadow router 210 is connected to first PE router 215 via a single “Gig E” interface. This way, shadow router 210 can use any operating system needed to support new functionality without posing a threat to the core network interior gateway protocol (IGP) or border gateway protocol (BGP) function. The physical Gig E interface has three virtual local areas networks (VLANs) associated with it: i) one for IPV4 Internet traffic VLAN 230; ii) one for VPN-V4 traffic (VPN, VLAN 240); and iii) one for internal service provider traffic (VLAN 250).

First PE router 215 is peered to a virtual router redundancy (VRR)-VPN route reflector so first PE router 215 has information about all MVPN customer routes.

These routes are filtered to prevent unneeded customer specific routes from entering first PE router 215's routing table. Only /32 management loop back addresses assigned to customer CPEs will be allowed in first PE router 215's management VPN VRF table (example 10.255.247.7./32). All other PE routers in service provider network 202 communicate with shadow router 110 via service provider backbone 225.

First PE router 215 and second PE router 220 provide performance measurement access, for example, to: i) first customer CPEs 230 and 235 via WAN interface addresses proximal to the CPE; ii) in region VPN customers (i.e. second customer CPEs 240 and 245); and 3) in and out-of-region customers using the MVPN (first customer CPEs 230 and 235 plus CPE 275). Shadow router 210 can reach the CPE devices via static routes. Since all CPEs have management addresses derived from, for example, the 10.160.0.0/14 range. The static routes can be summarized to control access to sensitive routes.

To reach non-VPN CPEs such as associated with Dedicated Internet Access (DIA) routers, internal traffic VLAN 230 is provisioned between shadow router 210 and first PE router 215. This VLAN can support IPV4 addressing. Since each non-VPN managed CPE has no loopback interface, management performance traffic can be directed to the physical WAN interface proximal on the DIA CPE router. This, for example, is how simple network management protocol (SNMP) functions are performed conventionally. Each WAN address is assigned by the service provider from globally unique address space. Further, these addresses come from a central pool of addresses. Thus, these routes can also be summarized for management access from shadow router 210 located within system 200. CPEs belonging to service provider customers not within the service provider network 202 will be reached using the MVPN extended into other provider's network 203.

Performance measurement processor 105, inventory/provisioning processor 110, network management tool processor 115, event receiver processor 120, and trouble management processor 155 (“the processors”) included in system 100 may be implemented using a personal computer, network computer, mainframe, or other similar microcomputer-based workstation. The processors may comprise any type of computer operating environment, such as hand-held devices, multiprocessor systems, microprocessor-based or programmable sender electronic devices, minicomputers, mainframe computers, and the like. The processors may also be practiced in distributed computing environments where tasks are performed by remote processing devices. Furthermore, any of the processors may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, or a facsimile machine. The aforementioned systems and devices are exemplary and the processors may comprise other systems or devices.

In addition to utilizing a wire line communications system in system 100, a wireless communications system, or a combination of wire line and wireless may be utilized in order to, for example, exchange web pages via the Internet, exchange e-mails via the Internet, or for utilizing other communications channels. Wireless can be defined as radio transmission via the airwaves. However, it may be appreciated that various other communication techniques can be used to provide wireless transmission, including infrared line of sight, cellular, microwave, satellite, packet radio, and spread spectrum radio. The processors in the wireless environment can be any mobile terminal, such as the mobile terminals described above. Wireless data may include, but is not limited to, paging, text messaging, e-mail, Internet access and other specialized data applications specifically excluding or including voice transmission. For example, the processors may communicate across a wireless interface such as, for example, a cellular interface (e.g., general packet radio system (GPRS), enhanced data rates for global evolution (EDGE), global system for mobile communications (GSM)), a wireless local area network interface (e.g., WLAN, IEEE 802.11), a bluetooth interface, another RF communication interface, and/or an optical interface.

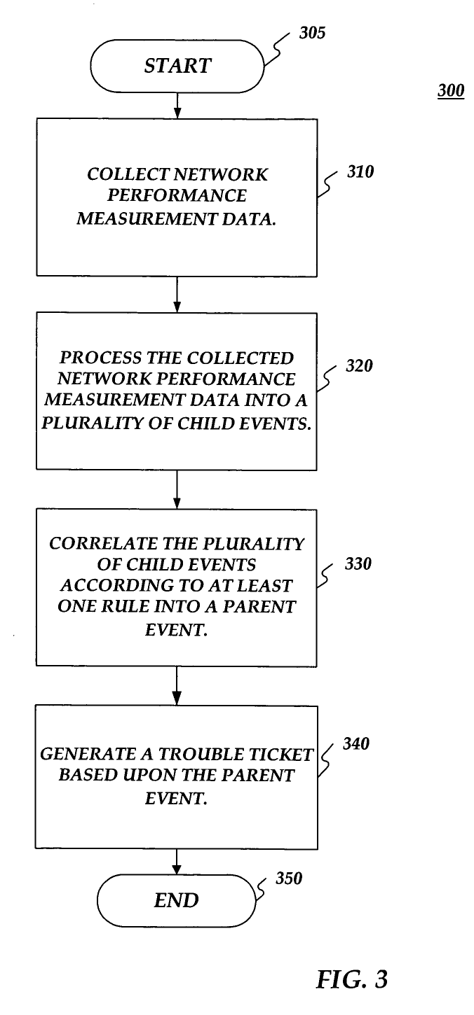

FIG. 3 is a flow chart setting forth the general stages involved in an exemplary method 300 consistent with the invention for providing outage notification using system 100 of FIG. 1. Exemplary ways to implement the stages of exemplary method 300 will be described in greater detail below. Exemplary method 300 begins at starting block 305 and proceed to stage 310 where performance management processor 125 collects network performance measurement data from network devices such as routers, switches and the interfaces on these devices. For example, event receiver processor 120 receives, through performance measurement processor 105, traps generated by shadow router 110 hosting, for example, SAAs. Event receiver processor 120 also receives traps generated by the performance management processor 125 on traffic events (e.g., bandwidth utilization and QoS traffic polices packet drops). In addition, event receiver processor 120 may also receive traps on device or interface failures from other devices on the service provider network and also from direct polling of these devices, for example, for up/down status of the devices and interfaces on the devices. The collected network performance measurement data may comprise, but is not limited to, delay round trip, delay one way, jitter round trip, jitter one way, packet loss round trip, packet loss one way, and packets out of sequence. Moreover, the network performance measurement data may also comprise data relating to at least one of bandwidth utilization on the service provider network, for example on the interface from CPE to the PE, QoS Traffic policer values, and the up/down status of devices on the service provider network.

From stage 310, where event receiver processor 120 collects network performance measurement data, exemplary method 300 advances to stage 320 where event receiver processor 120 processes the collected network performance measurement data into a plurality of child events. For example, event receiver processor 120 processes the traps and creates child event with the information contained in the traps. These child events may be in a format and protocol acceptable by network management tool processor 115. Furthermore, processing the collected network performance measurement data in to the plurality of child events may comprise, for example, processing the collected network performance measurement data in to the plurality of child events wherein one of the plurality of child events indicates a traffic flow measurement indicating >1% of packet loss or one way latency of >80 ms.

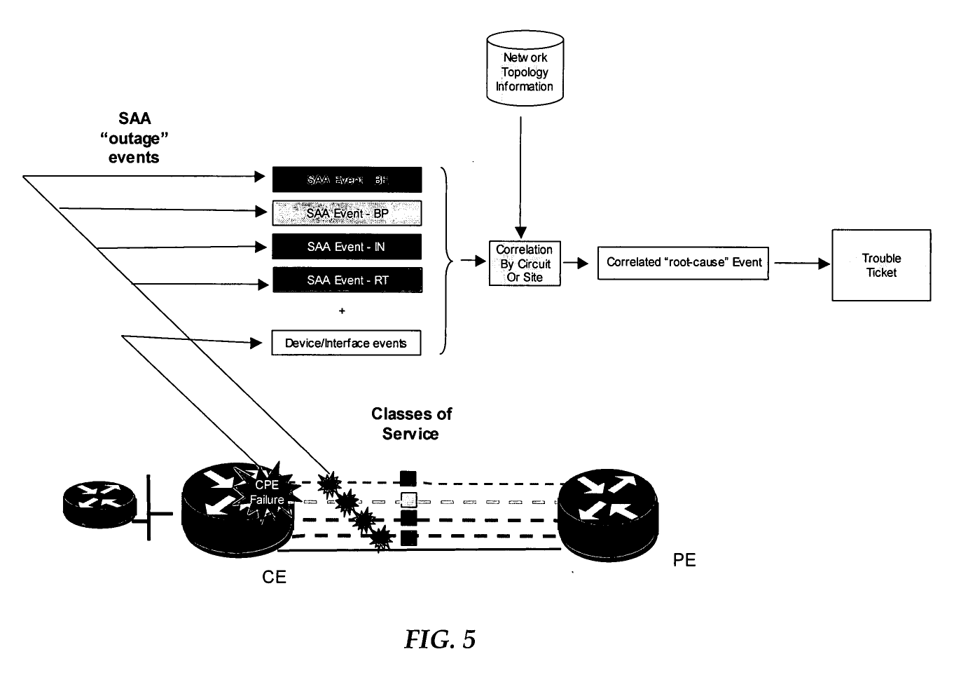

Once event receiver processor 120 processes the collected network performance measurement data into a plurality of child events in stage 320, exemplary method 300 continues to stage 330 where network management tool processor 115 correlates the plurality of child events according to at least one rule into a parent event. For example, when correlating child events corresponding to SAA events, SAA topology information is used. The SAA topology information is maintained in a first SAA database 130 located on inventory/provisioning processor 110. The information from first SAA database 130 is retrieved and cached in network management tool processor 115 run-time memory 135 through adapter 140 and message bus system 145. When an SAA event is received by network management tool processor 115, an event enrichment processor 150 performs a lookup in the aforementioned memory cash for the SAA topology information and enriches the event with the information needed for correlation. Following the event enrichment, correlation rules in network management tool processor 115 will be triggered for correlating various events to a parent event. As shown in FIG. 5, for example, network management tool processor 115 correlates child events to a single root cause (parent) event and may suppress all symptomatic events according to at least one rule. One such rule, for example, may correlate all events against a site ID (circuit ID) to a single event. For example, a device event (e.g. a CPE failure) will generate a CPE device down event in addition to the four other SAA events shown in FIG. 5. All these events are correlated into a single root cause (parent) event, for example, against the site or the circuit. The aforementioned rule is exemplary and other may be used.

After network management tool processor 115 correlates the plurality of child events according to at least one rule into a parent event in stage 330, exemplary method 300 continues to stage 340 where trouble management processor 155 generates a trouble ticket based upon the parent event. For example, following correlation, network management processor 115 opens, for example, a trouble ticket in trouble management processor 155 corresponding to the customer site impacted with the appropriate information. The trouble ticket may indicate any affected device on the service provider network including devices in the customer premises. After trouble management processor 155 generates a trouble ticket based upon the parent event in stage 340, exemplary method 300 then ends at stage 350.

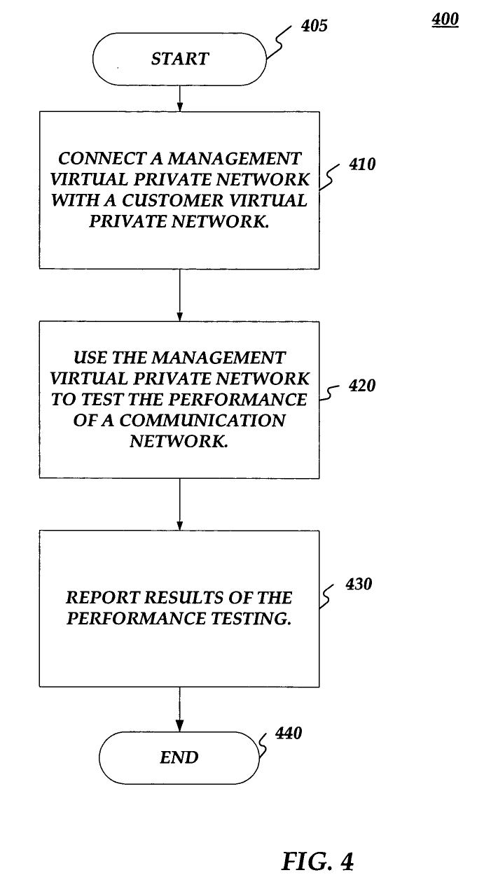

FIG. 4 is a flow chart setting forth the general stages involved in an exemplary method 400 consistent with an exemplary embodiment of the invention for providing performance testing using system 200 of FIG. 2. Exemplary ways to implement the stages of exemplary method 400 will be described in greater detail below. Exemplary method 400 begins at starting block 405 and proceeds to stage 410 where performance processor 105 communicates with a MVPN which in turn communicates to a CVPN. The MVPN and the CVPN are configured to recognize each other's presence. To accomplish this, as described below, the MVPN and the CVPN may use a routing protocol such as border gateway protocol (BGP). BGP is a routing protocol that spans autonomous systems on, for example, the Internet.

A virtual routing and forwarding interface (VRF) is constructed for the MVPN. This management virtual routing and forwarding interface (MVRF) is constructed in PE router (220, 215, etc.). Then the MVRF is given a route descriptor. This router descriptor is unique to the router on which the MVRF resides (e.g. PE router 215 or 220, etc.). Next, the MVRF is given a route target. This MVRF route target is a series of numbers that defines a virtual routing and forwarding table (VRF). For example, in this MVRF route target, the export and import says for all the PE routers that are participating in this VRF (i.e. first PE router 215 and second PE router 220), exchange information with 65534 on it as illustrated in Table 1 below. That is, shadow router 215 or 220 may communicate that it has a number of routes and if any PE routers want to have them, they should look for RT (route target) 65534. Likewise, first PE router 215 and second PE router 220 are going to import data into their tables if they see data coming labeled with 65534.

TABLE 1

ip vrf BLS_MGT_VPN_001
rd A.B.C.D:E
export map REDIS_INTO_CUST
route-target export 6389:65534
route-target import 6389:65534
route-target import 6389:65532

For the customer CPE to be able to interact with shadow router 110, the CVPN needs to have knowledge of how to route to shadow router 210. Thus, the MVPN exports management routes to the CVPN. This route information sharing from the MVPN to a CVPN is called route redistribution.

For each CVPN on any given PE, selected management routes are imported into the CVPN. However, to redistribute management routes to CVPNs, more control may be used. This control is offered via the route-map REDIS_INTO_CUST as shown in Table 2. This route-map utilizes the prefix-list MGMT_TO_CUST. The prefixes included in this list include prefixes for all devices in the MVRF.

TABLE 2

route-map REDIS_INTO_CUST permit 10
match ip address prefix-list MGMT_TO_CUSTOMER
set extcommunity rt 6389:65533 additive

Letting the CVPN learn routes to the MVRF devices allows MVPN customer CPEs to communicate with shadow router 210 for information, for example, relating to link utilization, class utilization, etc., directly. The route map REDIS_INTO_CUST, as shown in Table 2, searches for a matching management prefix via the prefix list MGMT_TO_CUSTOMER and, if a match is found, it appends the extended community 6389:65533 onto that management prefix. This will then be imported into the CVPN.

From stage 410, where a PE (215, 220, etc.) participating in the management VPN connects the MVPN with the CVPN, exemplary method 400 advances to stage 420 where performance processor 105 uses the MVPN to test the performance of a communication network. The communication network includes the MVPN and the CVPN. Because the MVPN and the CVPN recognize each other, performance processor 105 (embedded in shadow router 210) can probe the service provider network even into the CVPNs. For example, consistent with embodiment of the invention, performance processor 105 executes a performance software module to perform, but not limited to any one or more of the following functions: i) measure network performance (delay round trip, delay one way, jitter round trip, jitter one way, packet loss round trip, packet loss one way, packets out of sequence) across any layer 2 access method (e.g. Frame Relay, Ethernet, ATM); ii) measure network performance within a CVRF from a single or more than one device that is not directly a part of the CVRF; iii) measure network performance either within the service provider territory or across another provider network using, for example, an inter-provider VPN model; and iv) measure end-to-end network performance from CPE to the service provider network core, core and across another access line without needing to run a specific test from a customer's first CPE to a customer's second CPE.

For example, the service provider may wish to measure performance from one point in system 200 to another in order to enforce, for example, a service level agreement between the customer and the service provider. The customer may expect a certain amount of performance from the service provider and may pay more money, per the service level agreement, for higher service levels. Using processor 105 as described above, the service provider measures the performance between first customer CPE 230 and service provider backbone 225 (i.e. piece A). In addition, processor 105 can measure the performance of service provider backbone 225 (i.e. piece B). Furthermore, using processor 105, as described above, the service provider can measure the performance between second customer CPE 235 and service provider backbone 225 (i.e. piece C). Taking all three (pieces A, B, and C), performance processor 105 measures “end-to-end” performance, for example, from first customer CPE 230, through service provider backbone 225, and through second customer CPE 235. In order to provide performance measurement, processor 105 may also utilize SAA.

Consistent with embodiments of the invention, system 200 can obtain current time data via a satellite 280 and provide the time to all devices in system 200 in order, for example, to provide better performance measurements. For example, shadow router 210 may provide to the CPE current and accurate timing information through service provider network 202.

Once performance processor 105 uses the management virtual private network to test the performance of a communication network in stage 420, exemplary method 400 continues to stage 430 where performance processor 105 reports results of the performance testing. For example, performance processor 105 gathers the performance information and sends it to a customer associated with the CVPN or to the service provider. After performance processor 105 reports results of the performance testing in stage 430, exemplary method 400 then ends at stage 440.

Embodiments of the invention may use multi protocol label switching (MPLS). MPLS is a standards-approved technology for speeding up network traffic flow and making it easier to manage. It involves setting up a specific path for a given sequence of packets, identified by a label placed in each packet, thus saving the time needed for a router to look up the address to the next node to forward the packet to. MPLS works with the internet protocol (IP), asynchronous transport mode (ATM), and frame relay (FR) network protocol. With reference to the standard model for a network (the open systems interconnection, or OSI model), MPLS allows most packets to be forwarded at the layer 2, (switching level) rather than at the layer 3 (routing level). In addition to moving traffic faster overall, MPLS makes it easy to manage a network for quality of service (QoS).

Embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The present invention may be embodied as systems, methods, and/or computer program products. Accordingly, the present invention may be embodied in hardware and/or in software (including firmware, resident software, micro-code, etc.). Furthermore, embodiments of the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described above with reference to block diagrams and/or operational illustrations of methods, systems, and computer program products according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

While certain features and embodiments of the invention have been described, other embodiments of the invention may exist. Furthermore, although embodiments of the present invention have been described as being associated with data stored in memory and other storage mediums, these aspects may also be stored on or read from other types of computer-readable media, such as secondary storage devices, like hard disks, floppy disks, or a CD-ROM, a carrier wave from the Internet, or other forms of RAM or ROM. Further, the stages of the disclosed methods may be modified in any manner, including by reordering stages and/or inserting or deleting stages, without departing from the principles of the invention.

It is intended, therefore, that the specification and examples be considered as exemplary only, with a true scope and spirit of the invention being indicated by the following claims and their full scope of equivalents.

What is claimed is:

1. A method for providing service performance degradation and network failure detection and notification, the method comprising:
collecting network performance measurement data on an internet protocol multi protocol label switching network supporting multiple classes of service quality;
processing the collected network performance measurement data into a plurality of child events;
correlating the plurality of child events according to at least one rule into a parent event; and
generating a trouble ticket based upon the parent event.

2. The method of claim 1, wherein collecting the network performance measurement data comprises collecting the network performance measurement data comprising data relating to at least one of the following: bandwidth utilization, quality of service, and the up/down status of devices on a network.

3. The method of claim 1, wherein collecting the network performance measurement data comprises collecting the network performance measurement data comprising at least one of: delay round trip, delay one way, jitter round trip, jitter one way, packet loss round trip, packet loss one way, and packets out of sequence.

4. The method of claim 1, wherein collecting the network performance measurement data comprises collecting the network performance measurement data across any layer 2 access method.

5. The method of claim 1, wherein processing the collected network performance measurement data in to the plurality of child events comprises processing the collected network performance measurement data in to the plurality of child events wherein one of the plurality of child events indicates at least one of the following: a traffic flow measurement indicating >1% of packet loss and one way latency of >80 ms.

6. The method of claim 1, wherein correlating the plurality of child events according to at the least one rule into the parent event comprises correlating the plurality of child events according to at the least one rule into the parent event comprises receiving topology information relative to at least one of the child events and enriching with the received topology information the at least one child event corresponding to the received topology information.

7. The method of claim 1, wherein generating the trouble ticket based upon the parent event comprises generating the trouble ticket indicating an affected device located in a private network.

8. A system for providing outage notification, the system comprising:
a memory storage for maintaining a database; and
a processing unit coupled to the memory storage, wherein the processing unit is operative to:
collect network performance measurement data;
process the collected network performance measurement data in to a plurality of child events;
correlate the plurality of child events according to at least one rule into a parent event; and
generate a trouble ticket based upon the parent event.

9. The system of claim 8, wherein the processing unit operative to collect the network performance measurement data comprises the processing unit operative to collect the network performance measurement data comprising data relating to at least one of the following: bandwidth utilization, quality of service, and the up/down status of devices on a network.

10. The system of claim 8, wherein the processing unit operative to collect the network performance measurement data comprises the processing unit operative to collect the network performance measurement data comprising at least one of: delay round trip, delay one way, jitter round trip, jitter one way, packet loss round trip, packet loss one way, and packets out of sequence.

11. The system of claim 8, wherein the processing unit operative to collect the network performance measurement data comprises the processing unit operative to collect the network performance measurement data across any layer 2 access method.

12. The system of claim 8, wherein the processing unit operative to process the collected network performance measurement data in to the plurality of child events comprises the processing unit operative to process the collected network performance measurement data in to the plurality of child events wherein one of the plurality of child events indicates at least one of the following: a traffic flow measurement indicating >1% of packet loss and one way latency of >80 ms.

13. The system of claim 8, wherein the processing unit operative to correlate the plurality of child events according to at the least one rule into the parent event comprises the processing unit operative to correlate the plurality of child events according to at the least one rule into the parent event comprises receiving topology information relative to at least one of the child events and enriching with the received topology information the at least one child event corresponding to the received topology information.

14. A computer-readable medium which stores a set of instructions which when executed performs a method for providing outage notification, the method executed by the set of instructions comprising:
collecting network performance measurement data;
processing the collected network performance measurement data in to a plurality of child events;
correlating the plurality of child events according to at least one rule into a parent event; and
generating a trouble ticket based upon the parent event.

15. The computer-readable medium of claim 14, wherein collecting the network performance measurement data comprises collecting the network performance measurement data comprising data relating to at least one of the following: bandwidth utilization, quality of service, and the up/down status of devices on a network.

16. The computer-readable medium of claim 14, wherein collecting the network performance measurement data comprises collecting the network performance measurement data comprising at least one of: delay round trip, delay one way, jitter round trip, jitter one way, packet loss round trip, packet loss one way, and packets out of sequence.

17. The computer-readable medium of claim 14, wherein collecting the network performance measurement data comprises collecting the network performance measurement data across any layer 2 access method.

18. The computer-readable medium of claim 14, wherein processing the collected network performance measurement data in to the plurality of child events comprises processing the collected network performance measurement data in to the plurality of child events wherein one of the plurality of child events indicates at least one of the following: a traffic flow measurement indicating >1% of packet loss and one way latency of >80 ms.

19. The computer-readable medium of claim 14, wherein correlating the plurality of child events according to at the least one rule into the parent event comprises correlating the plurality of child events according to at the least one rule into the parent event comprises receiving topology information relative to at least one of the child events and enriching with the received topology information the at least one child event corresponding to the received topology information.

20. The computer-readable medium of claim 14, wherein generating the trouble ticket based upon the parent event comprises generating the trouble ticket indicating an affected device located in a private network.
